(19) United States
(12) Patent Application Publication
(10) Pub. No.: US 2021/0248476 A1
(43) Pub. Date: Aug. 12, 2021

(54) Machine-Learned Models Featuring Matrix Exponentiation Layers

(71) Applicant: Google LLC, Mountain View, CA (US)

(72) Inventors: Thomas Fischbacher, Zurich (CH); Iulia-Maria Comsa, Zurich (CH); Luca Versari, Zurich (CH)

(21) Appl. No.: 17/170,025

(22) Filed: Feb. 8, 2021

Related U.S. Application Data
(60) Provisional application No. 62/971,006, filed on Feb. 6, 2020.
(60) Provisional application No. 62/970,983, filed on Feb. 6, 2020.

(51) Int. Cl. G06N 3/08; G06N 3/04; G06N 20/00; G06K 9/62; G06F 17/16

(52) U.S. Cl. CPC G06N 3/084; G06N 3/04; G06F 17/16; G06K 9/6267; G06N 20/00

(57) ABSTRACT

The present disclosure proposes a model that has more expressive power, e.g., can generalize from a smaller amount of parameters and assign more computation in areas of the function that need more computation. In particular, the present disclosure is directed to novel machine learning architectures that use the exponential of an input-dependent matrix as a nonlinearity. The mathematical simplicity of this architecture allows a detailed analysis of its behavior, providing stringent robustness guarantees via Lipschitz bounds.

### RELATED APPLICATIONS

This application claims priority to and the benefit of U.S. Provisional Patent Application No. 62/970,983, filed Feb. 6, 2020, and U.S. Provisional Patent Application No. 62/971,006, filed Feb. 6, 2020. Each of U.S. Provisional Patent Application No. 62/970,983, filed Feb. 6, 2020, and U.S. Provisional Patent Application No. 62/971,006, filed Feb. 6, 2020 is hereby incorporated by reference in its entirety.

### FIELD

The present disclosure relates generally to machine learning. More particularly, the present disclosure relates to machine-learned models which feature one or more matrix exponentiation layers.

### BACKGROUND

Deep neural networks (DNNs) synthesize highly complex functions by composing a large number of neuronal units, each featuring a basic and usually 1-dimensional nonlinear function. While highly successful in practice, this approach has certain disadvantages. In a conventional DNN, any two activations only ever get combined through summation. For example, to approximate feature multiplication, the network would need to synthesize A·B=aexp(alog A+alog B), where aexp and alog are “approximate exponentials” and “approximate logarithms”, or another effectively equivalent operation. Furthermore, the network would need to use different parameter subsets to learn the same function when applied to different arguments, and expend additional effort to also correctly handle the sign of the result.

The composition of such functions, for example in ReLU-based DNNs, which are fundamentally piecewise functions, creates complicated mathematical structures that are not easy to analyze. Hence, it is difficult to provide tight robustness guarantees for such networks. With an increasing number of machine learning (ML) models used in the real world, robustness is an outstanding topic in ensuring the safety of their usage.

### SUMMARY

Aspects and advantages of embodiments of the present disclosure will be set forth in part in the following description, or can be learned from the description, or can be learned through practice of the embodiments.

One example aspect of the present disclosure is directed to a computing system, comprising: one or more processors; and one or more non-transitory computer-readable media that collectively store: a machine-learned model configured to receive and process a model input to generate a model output, wherein the machine-learned model comprises one or more matrix exponentiation layers. Each of the one or more matrix exponentiation layers is configured to perform layer operations, the layer operations comprising: receiving a layer input; generating an intermediate matrix based on the layer input; performing matrix exponentiation on the intermediate matrix to obtain an exponentiated matrix; and generating a layer output based on the exponentiated matrix. The non-transitory computer-readable media store instructions that, when executed by the one or more processors, cause the computing system to perform system operations, the system operations comprising: receiving the model input; and processing the model input with the machine-learned model to generate the model output.

In some implementations, the one or more matrix exponentiation layers comprise a single matrix exponentiation layer.

In some implementations, the one or more matrix exponentiation layers comprise a plurality of matrix exponentiation layers.

In some implementations, the plurality of matrix exponentiation layers are stacked in a sequence one after the other.

In some implementations, generating the intermediate matrix based on the layer input comprises: projecting the layer input to a latent feature embedding space to obtain an embedding tensor; and mapping the embedding tensor to obtain an unbiased intermediate matrix.

In some implementations, projecting the layer input to the latent feature embedding space to obtain the embedding tensor comprises using a first projection tensor to linearly project the layer input to the embedding tensor.

In some implementations, the first projection tensor comprises one or more learned parameter values.

In some implementations, mapping the embedding tensor to obtain the unbiased intermediate matrix comprises multiplying the embedding tensor with a mapping tensor.

In some implementations, the mapping tensor comprises one or more learned parameter values.

In some implementations, generating the intermediate matrix based on the layer input comprises mapping the layer input to obtain an unbiased intermediate matrix.

In some implementations, generating the intermediate matrix based on the layer input further comprises: adding a first bias tensor to the unbiased intermediate matrix to obtain the intermediate matrix.

In some implementations, the first bias tensor comprises one or more learned parameter values.

In some implementations, generating the layer output based on the exponentiated matrix comprises using a second projection tensor to linearly project the exponentiated matrix to an unbiased layer output.

In some implementations, the second projection tensor comprises one or more learned parameter values.

In some implementations, generating the layer output based on the exponentiated matrix further comprises adding a second bias tensor to the layer output.

In some implementations, the second bias tensor comprises one or more learned parameter values.

In some implementations, the machine-learned model is configured to generate the model output based at least in part on the layer output of a last matrix exponentiation layer of the one or more matrix exponentiation layers.

In some implementations, the machine-learned model further comprises a softmax layer that obtains the layer output of a last matrix exponentiation layer of the one or more matrix exponentiation layers.

In some implementations, the machine-learned model further comprises one or more hidden neural network layers that one or both of precede or follow the one or more matrix exponentiation layers.

In some implementations, the intermediate matrix is an affine function of the layer input.

In some implementations, performing matrix exponentiation on the intermediate matrix to obtain an exponentiated matrix comprises: performing matrix exponentiation on the intermediate matrix and subtracting a matrix exponential of zero from the result to obtain the exponentiated matrix.

In some implementations, the intermediate matrix comprises a feature weighted sum.

In some implementations, the system operations further comprise learning, based on a set of training data, improved values for one or more of: the first projection tensor; the mapping tensor; the first bias tensor; the second projection tensor; and/or the second bias tensor.

In some implementations, learning comprises performing one or more gradient-based optimization techniques comprising backpropagating a loss through the matrix exponentiation.

Another example aspect of the present disclosure is directed to a computing system, comprising: one or more processors; and one or more non-transitory computer-readable media that collectively store: a machine-learned embedding model configured to receive and process a model input to generate a numerical embedding representation for the model input. The machine-learned embedding model comprises one or more matrix exponentiation layers. Each of the one or more matrix exponentiation layers is configured to perform layer operations, the layer operations comprising: receiving a layer input; generating an intermediate matrix based on the layer input; performing matrix exponentiation on the intermediate matrix to obtain an exponentiated matrix; and generating a layer output based on the exponentiated matrix. The one or more non-transitory computer-readable media store instructions that, when executed by the one or more processors, cause the computing system to perform system operations, the system operations comprising: receiving the model input; and processing the model input with the machine-learned embedding model to generate the numerical embedding representation for the model input.

In some implementations, the one or more matrix exponentiation layers comprise a single matrix exponentiation layer.

In some implementations, the one or more matrix exponentiation layers comprise a plurality of matrix exponentiation layers.

In some implementations, the plurality of matrix exponentiation layers are stacked in a sequence one after the other.

In some implementations, generating the intermediate matrix based on the layer input comprises: projecting the layer input to a latent feature embedding space to obtain an embedding tensor; and mapping the embedding tensor to obtain an unbiased intermediate matrix.

In some implementations, projecting the layer input to the latent feature embedding space to obtain the embedding tensor comprises using a first projection tensor to linearly project the layer input to the embedding tensor.

In some implementations, the first projection tensor comprises one or more learned parameter values.

In some implementations, mapping the embedding tensor to obtain the unbiased intermediate matrix comprises multiplying the embedding tensor with a mapping tensor.

In some implementations, the mapping tensor comprises one or more learned parameter values.

In some implementations, generating the intermediate matrix based on the layer input comprises mapping the layer input to obtain an unbiased intermediate matrix.

In some implementations, generating the intermediate matrix based on the layer input further comprises: adding a first bias tensor to the unbiased intermediate matrix to obtain the intermediate matrix.

In some implementations, the first bias tensor comprises one or more learned parameter values.

In some implementations, generating the layer output based on the exponentiated matrix comprises using a second projection tensor to linearly project the exponentiated matrix to an unbiased layer output.

In some implementations, the second projection tensor comprises one or more learned parameter values.

In some implementations, generating the layer output based on the exponentiated matrix further comprises adding a second bias tensor to the layer output.

In some implementations, the second bias tensor comprises one or more learned parameter values.

In some implementations, the numerical embedding representation comprises the layer output of a last matrix exponentiation layer of the one or more matrix exponentiation layers.

In some implementations, the machine-learned embedding model further comprises one or more hidden neural network layers that one or both of precede or follow the one or more matrix exponentiation layers.

In some implementations, the intermediate matrix is an affine function of the layer input.

In some implementations, performing matrix exponentiation on the intermediate matrix to obtain an exponentiated matrix comprises: performing matrix exponentiation on the intermediate matrix and subtracting a matrix exponential of zero from the result to obtain the exponentiated matrix.

In some implementations, the intermediate matrix comprises a feature weighted sum.

In some implementations, the numerical embedding representation comprises a continuous representation represented using floating-point numbers.

In some implementations, the numerical embedding representation resides within an embedding space that facilitates multi-dimensional assessment.

In some implementations, the system operations further comprise learning, based on a set of training data, improved values for one or more of: the first projection tensor; the mapping tensor; the first bias tensor; the second projection tensor; and/or the second bias tensor.

In some implementations, said learning comprises performing one or more gradient-based optimization techniques comprising backpropagating a loss through the matrix exponentiation.

Another example aspect of the present disclosure is directed to a computer-implemented method. The method includes obtaining, by one or more computing devices, a numerical embedding representation for a data input, wherein the numerical embedding representation was generated for the data input by a machine-learned embedding model that comprises one or more matrix exponentiation layers, wherein each of the one or more matrix exponentiation layers is configured to generate an intermediate matrix based on a layer input, perform matrix exponentiation on the intermediate matrix to obtain an exponentiated matrix, and generate a layer output based on the exponentiated matrix; and performing, by the one or more computing devices, a task with respect to the data input based at least in part on the numerical embedding representation.

In some implementations, performing, by the one or more computing devices, the task with respect to the data input based at least in part on the numerical embedding representation comprises classifying, by the one or more computing devices, the data input based at least in part on the numerical embedding representation.

In some implementations, classifying, by the one or more computing devices, the data input based at least in part on the numerical embedding representation comprises: inputting, by the one or more computing devices, the numerical embedding representation into a machine-learned classification model configured to classify data inputs based on their embedding representations; and receiving, by the one or more computing devices, a classification of the data input as an output of the machine-learned classification model.

In some implementations, performing, by the one or more computing devices, the task with respect to the data input based at least in part on the numerical embedding representation comprises performing, by the one or more computing devices, a similarity search for the data input based at least in part on the numerical embedding representation.

In some implementations, performing, by the one or more computing devices, the task with respect to the data input based at least in part on the numerical embedding representation comprises clustering, by the one or more computing devices, the data input with one or more other data inputs based at least in part on the numerical embedding representation.

In some implementations, performing, by the one or more computing devices, the task with respect to the data input based at least in part on the numerical embedding representation comprises generating, by the one or more computing devices and using a machine-learned model, a prediction based at least in part on the numerical embedding representation.

Another example aspect of the present disclosure is directed to a computer-implemented method comprising performing, by one or more computing devices, some or all of the operations described herein.

Another example aspect of the present disclosure is directed to one or more non-transitory computer-readable media that store: a machine-learned model as described herein.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 2 depicts a graphical diagram of an example matrix exponentiation layer architecture according to example embodiments of the present disclosure.

Reference numerals that are repeated across plural figures are intended to identify the same features in various implementations.

### DETAILED DESCRIPTION

Overview

Machine learning methods used today approximate a function with lots of parameters, leading to overfitting and to a failure to generalize. In contrast, the present disclosure proposes a model that has more expressive power, e.g., can generalize from a smaller amount of parameters and assign more computation in areas of the function that need more computation. In particular, the present disclosure is directed to novel machine learning architectures that use the exponential of an input-dependent matrix as a nonlinearity. The mathematical simplicity of this architecture allows a detailed analysis of its behavior, providing stringent robustness guarantees via Lipschitz bounds.

Example implementations of the models proposed herein achieve results comparable to recently-proposed non-specialized architectures on image recognition datasets. The proposed model architectures can improve convolutional architectures, the use of various regularization methods, and potential work on interpretability based on its links to Lie group theory. Particularly, the proposed models easily learn relations about rhythms, hyper-volumes, hyper-geometry, and in general more complex non-linearities between input and output.

The systems, methods, and architectures described in this specification have been found to provide for efficient trainability while using far fewer parameters compared to multi-layer perceptron architectures of comparable performance. One advantage of this is that the resulting model may be represented in computer memory with less memory resources. Other advantages of fewer parameters is that the model can be trained faster and run faster (e.g., lower latency). Moreover, the resulting model may also have more expressive power, i.e. may be able to generalize from a smaller amount of parameters and assign more computation in areas of the function that need more computation. Methods described in this specification can be particularly adapted for efficient operation on hardware accelerators.

In some implementations, the architecture described in this specification can be used as a student model in a distillation training scenario in which a student model learns to predict the outputs of a teacher model. In some implementations, the architecture described in this specification can be particularly advantageous (e.g., due to its smaller size) for execution in resource constrained environments such as user devices, mobile devices, edge devices, IoT devices, embedded devices, and/or the like.

The architecture described in this specification may be used in a variety of tasks and is particularly suited to tasks which leverage hidden periodic structure in the input without requiring manual feature engineering.

For example, the task may be audio compression task. The input may include audio data and the output may comprise compressed audio data.

In another example, the input includes visual data (e.g. one or more image or videos), the output comprises compressed visual data, and the task is a visual data compression task.

In another example, the task may comprise generating an embedding for input data (e.g. input audio or visual data). Use of a matrix exponential layer may allow the network to learn features of the embedding space with geometric meaning, paving the way for better generalization abilities and better interpretability of the model. For example, methods described in this specification may provide an embedding space with an even richer geometric structure which allows use of generalized notions of “area” or “volume”. Methods described in this specification may generate embeddings with fewer training examples compared to known methods, leading to faster training.

In some cases, the input includes visual data and the task is a computer vision task. In some cases, the input includes pixel data for one or more images and the task is an image processing task.

For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance.

In some cases, the task comprises encoding input data for reliable and/or efficient transmission or storage (and/or corresponding decoding).

In some cases, the task comprises encrypting or decrypting input data.

In some cases, the task comprises a microprocessor performance task, such as branch prediction or memory address translation.

The systems and methods described herein address multiple problems. As one example, the proposed architectures have both good generalization properties and efficient trainability while only using few parameters.

The proposed architectures can be applied as an alternative to Deep Neural Networks in many situations and give comparable-or-better performance—especially where using a DNN might not be possible for various reasons such as resource constraints.

The proposed architectures allow models to directly utilize some hidden periodic structure in input signals without requiring manual feature engineering—e.g. recognizing that day-of-the-year is a signal for a user's behavior that has some 7-day periodicity, with a year-dependent offset (=the weekday of January 1st).

Example investigations show that this architecture is able to learn some sophisticated functions, such as matrix determinants, where conventional DNNs struggle a lot to make sense of the data.

As another example, this new architecture can be integrated with traditional DNNs for example as one or more of the layers in a hybrid architecture. This allows the new architecture reuse and integrate with existing models, such as models developed for machine vision.

Another example aspect of the present disclosure is directed to assessment problems involve gauging whether the observed evidence covers multiple relevant dimensions. The range of problems where this matters is large, including scoring homework essays (where a relevant question is whether the topic was discussed from multiple different important angles), microprocessor performance (where it is important not only to be fast on floating point operations, but also branch prediction, memory address translation, and some similar such primitives), or assessing whether a hiring candidate is a specialist or a generalist.

The machine learning approaches proposed herein can learn to make predictions for such assessment tasks by using the characteristics of the proposed matrix exponentiation architecture that has been demonstrated to be especially good at estimating functions that involve some notion of ‘volume’, which here in a rather direct way corresponds to the volume spanned by different pieces of evidence in some higher-dimensional learned numerical embedding space.

More particularly, learned higher-dimensional feature embeddings are a powerful method that allow machine learning architectures to process real world data. It has been observed that embedding spaces show surprising emergent geometric properties, such as putting a Cartesian structure on input data, which allows vector operations such as “find the (difference) vector that takes us from the embedding point of [Germany] to that of [France], and add this to [Berlin] to get a point near the embedding point of [Paris] (and not near any other geographical entity)”.

The architecture described herein naturally gives such an embedding space an even richer geometric structure, by allowing it to use generalized notions of “area” or “volume”. As one example, the determinant of a N×N matrix is naturally tied to the concept of N-dimensional volume: it is 0 if and only if all the columns of the matrix belong to the same N−1-dimensional subspace, and corresponds to the (signed) volume of the N-dimensional parallelepiped that has the columns of the matrix as edges. Considering the usefulness of this notion of inter-dependence between vectors, it is natural to consider generalizations of this concept.

A p-form is a multilinear, antisymmetric function of p vectors in N-dimensional space. This notion is a generalization of the determinant in the sense that it is well-known that any N-form in N-dimensional space is a multiple of the determinant. The usual 3-dimensional cross product, which corresponds to the signed area of the parallelogram that has the two vectors as edges, can also be seen as a 2-form on 3-dimensional space. Thus, it can be stated that a p-form defines a notion of (p-dimensional hyper-)volume in N-dimensional space.

The network architecture described herein has been shown to be able to learn functions that have geometric significance such as the determinant, but also lower-dimensional p-forms, which measure extent along multiple directions that nevertheless do not generate a volume in the full embedding space. Thus, enriching an embedding-based machine learning architecture with a matrix exponentiation layer allows the network to learn features of the embedding space with geometric meaning, paving the road for better generalization abilities and better interpretability of the model.

Thus, example aspects of the present disclosure provide a novel ML architecture (e.g., for supervised learning) whose core element is a single layer (which can be referred to as “M-layer”), that computes a single matrix exponential, where the matrix to be exponentiated is an affine function of the input features. The M-layer has universal approximator properties and allows closed-form per-example bounds for robustness. This architecture cam learn multivariate polynomials, such as matrix determinants, and can generalize periodic functions beyond the domain of the input without any feature engineering. Furthermore, the M-layer achieves results comparable to recently-proposed non-specialized architectures on image recognition datasets.

### Example Architecture

This section starts by refreshing the definition of the matrix exponential. It then defines the proposed M-layer model and explains its ability to learn particular functions such as polynomials and periodic functions. Finally, it provides closed-form per-example robustness guarantees.

Example Matrix Exponentiation

The exponential of a square matrix M is defined as:

$$exp ( M ) = {\sum }_{k = 0}^{∞} \frac{1}{k !} {M}^{k} \qquad ( 1 )$$

The matrix power M^{k} is defined inductively as M⁰=I, M^{k+1}=M·M^{k}, using the associativity of the matrix product; it is not an element-wise matrix operation.

Note that the expansion of exp(M) in Eq. (1) is finite for nilpotent matrices. A matrix M is called nilpotent if there exists a positive integer k such that M^{k}=0. Strictly upper triangular matrices are a canonical example.

Multiple algorithms for computing the matrix exponential efficiently have been proposed. TensorFlow implements tf.linalg.expm using the scaling and squaring method combined with the Padé approximation.

Example M-Layer

At the core of the proposed architecture is an M-layer that computes a single matrix exponential, where the matrix to be exponentiated is an affine function of all of the input features. In other words, an M-layer replaces an entire stack of hidden layers in a DNN.

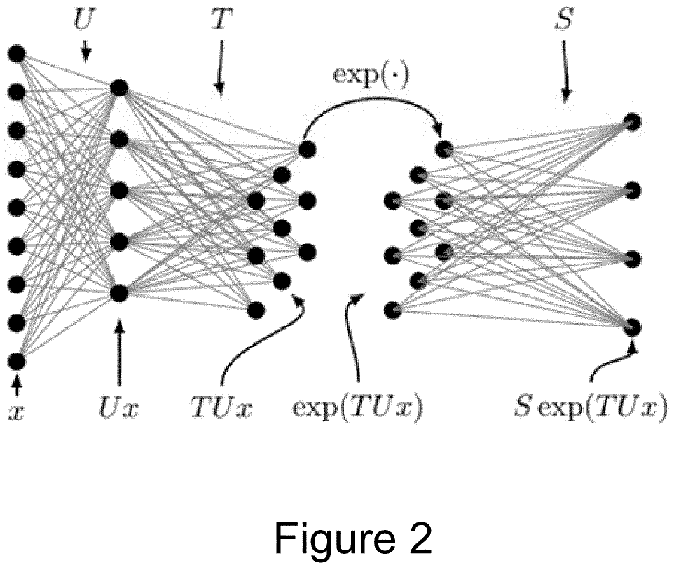

FIG. 2 shows a diagram of the proposed architecture of an example M-layer. The example architecture is shown and discussed as applied to a standard image recognition dataset, but note that this formulation is applicable to any other type of problem by adapting the relevant input indices. In the following equations, generalized Einstein summation is performed over all right-hand side indices not seen on the left-hand side. This operation can be implemented in TensorFlow by tf.einsum.

Consider an example input image, encoded as a 3-index array X_{yxc}, where y, x and c are the row index, column index and color channel index, respectively. The matrix M to be exponentiated is obtained as follows, using the trainable parameters \tilde{T}ₐⱼₖ, Ũ_{axyc} and \tilde{B}ⱼₖ:

M=\tilde{B}ⱼₖ+\tilde{T}ₐⱼₖŨ_{ayxc}X_{yxc} (2)

X can first be projected linearly to a d-dimensional latent feature embedding space by Ũ_{ayxc}. Then, the 3-index tensor \tilde{T}ₐⱼₖ can map each such latent feature to an n×n matrix. Finally, a bias matrix \tilde{B}ⱼₖ can be added to the feature-weighted sum of matrices. The result is a matrix indexed by row and column indices j and k.

It is possible to contract the tensors \tilde{T} and Ũ in order to simplify the architecture formula, but partial tensor factorization provides regularization by reducing the parameter count.

An output pₘ can be obtained as follows, using the trainable parameters \tilde{S}ₘⱼₖ and \tilde{V}ₘ:

pₘ=\tilde{V}ₘ+\tilde{S}ₘⱼₖ exp(M)ⱼₖ (3)

The matrix exp(M), indexed by row and column indices j and k in the same way as M, can be projected linearly by the 3-index tensor \tilde{S}ₘⱼₖ, to obtain a h-dimensional output vector. The bias-vector \tilde{V}ₘ turns this linear mapping into an affine mapping. The resulting vector may be interpreted as accumulated per-class evidence and, if desired, may then be mapped to a vector of probabilities via softmax.

Training can be done conventionally, by minimizing a loss function such as the L₂ norm or the cross-entropy with softmax, using backpropagation through matrix exponentiation.

The nonlinearity of the M-layer architecture is provided by the [symbol] ^{d}→ [symbol] ^{h} mapping v [symbol] \tilde{V}ₘ+\tilde{S}ₘⱼₖexp(M)ⱼₖ. The count of trainable parameters of this component is dn²+n²+n^{t}h+h. This count comes from summing the dimensions of \tilde{T}ₐⱼₖ, \tilde{B}ⱼₖ, \tilde{S}ₘⱼₖ, and \tilde{V}ₘ respectively. Note that this architecture has some redundancy in its parameters, as one can freely multiply the T and U tensors by a d×d real matrix and, respectively, its inverse, while preserving the computed function. Similarly, it is possible to multiply each of the n×n parts of the tensors \tilde{T} and \tilde{S}, as well as B, by both an n×n matrix and its inverse. In other words, any pair of real invertible matrices of sizes d×d and n×n can be used to produce a new parametrization that still computes the same function.

Example Feature Crosses and Universal Approximation

One property of the M-layer is its ability to generate arbitrary exponential-polynomial combinations of the input features. For classification problems, M-layer architectures are a superset of multivariate polynomial classifiers, where the matrix size constrains the complexity of the polynomial while at the same time not uniformly constraining its degree. In other words, simple multivariate polynomials of high degree compete against complex multivariate polynomials of low degree.

Consider a dataset with the feature vector (ϕ₀, ϕ₁, ϕ₂) given by the Ũ·x tensor contraction, where the relevant quantities for the final classification of an example are assumed to be ϕ₀, ϕ₁, ϕ₂, ϕ₀ϕ₁, and ϕ₁ϕ₂². To learn this dataset, look for an exponentiated matrix that makes precisely these quantities available to be weighted by the trainable tensor \tilde{S}. To do this, define three 7×7 matrices T₀ⱼₖ, T₁ⱼₖ, and T₂ⱼₖ as T₀₀₁=T₁₀₂=T₂₀₃=1, T₀₂₄=T₂₂₅=², T₂₅₆=3, and 0 otherwise. Define the matrix M as:

$$M = {ϕ}_{0} {T}_{0} + {ϕ}_{1} {T}_{1} + {ϕ}_{2} {T}_{2} = ( \begin{matrix}0 & {ϕ}_{0} & {ϕ}_{1} & {ϕ}_{2} & 0 & 0 & 0 \\ 0 & 0 & 0 & 0 & 0 & 0 & 0 \\ 0 & 0 & 0 & 0 & 2 {ϕ}_{0} & 2 {ϕ}_{2} & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 3 {ϕ}_{2} \\ 0 & 0 & 0 & 0 & 0 & 0 & 0\end{matrix} )$$

Note that M is nilpotent, as M⁴=0. Therefore, we obtain the following matrix exponential, which contains the desired quantities in its leading row:

$$exp ( M ) = I + M + \frac{1}{2} {M}^{2} + \frac{1}{6} {M}^{3} == ( \begin{matrix}1 & {ϕ}_{0} & {ϕ}_{1} & {ϕ}_{2} & {ϕ}_{0} {ϕ}_{1} & {ϕ}_{1} {ϕ}_{2} & {ϕ}_{1} {ϕ}_{2}^{2} \\ 0 & 1 & 0 & 0 & 0 & 0 & 0 \\ 0 & 0 & 1 & 0 & 2 {ϕ}_{0} & 2 {ϕ}_{2} & 3 {ϕ}_{2}^{2} \\ 0 & 0 & 0 & 1 & 0 & 0 & 0 \\ 0 & 0 & 0 & 0 & 1 & 0 & 0 \\ 0 & 0 & 0 & 0 & 0 & 1 & 3 {ϕ}_{2} \\ 0 & 0 & 0 & 0 & 0 & 0 & 1\end{matrix} )$$

The same technique can be employed to encode any polynomial in the input features using a n×n matrix, where n is one unit larger than the total number of features plus the intermediate and final products that need to be computed. The matrix size can be seen as regulating the total capacity of the model for computing different feature crosses.

With this intuition, one can read the matrix as a “circuit breadboard” for wiring up arbitrary polynomials. When evaluated on features that only take values 0 and 1, any Boolean logic function can be expressed.

Example Feature Periodicity

While the M-layer is able to express a wide range of functions using the exponential of nilpotent matrices, non-nilpotent matrices can bring additional utility. One possible application of non-nilpotent matrices is learning the periodicity of input features. This is a problem where conventional DNNs struggle, as they cannot naturally generalize beyond the distribution of the training data. Here we illustrate how matrix exponentials can naturally fit periodic dependency on input features, without requiring an explicit specification of the periodic nature of the data.

Consider the matrix

$${M}_{r} = ( \begin{matrix}0 & - ω \\ ω & 0\end{matrix} )$$

We have

$$exp ( t {M}_{r} ) = ( \begin{matrix}cos ω t & - s in ω t \\ sin ω t & cos ω t\end{matrix} )$$

which is a 2d rotation by an angle of cot and thus periodic in t with period 2π/ω. This setup can fit functions that have an arbitrary period. Moreover, this representation of periodicity naturally extrapolates well when going beyond the range of the initial numerical data.

Example Connection to Lie Groups

The M-layer has a natural connection to Lie groups. Lie groups can be thought of as a model of continuous symmetries of a system such as rotations. There is a large body of mathematical theory and tools available to study the structure and properties of Lie groups, which may ultimately also help for model interpretability.

Every Lie group has associated a Lie algebra, which can be understood as the space of the small perturbations with which it is possible to generate the elements of the Lie group. As an example, the set of rotations of 3-dimensional space forms a Lie group; the corresponding algebra can be understood as the set of rotation axes in 3 dimensions. Lie groups and algebras can be represented using matrices, and by computing a matrix exponential one can map elements of the algebra to elements of the group.

In the M-layer architecture, the role of the 3-index tensor \tilde{T} is to form a matrix whose entries are affine functions of the input features. The matrices that compose \tilde{T} can be thought of as generators of a Lie algebra. Building M corresponds to selecting a Lie algebra element. Matrix exponentiation then computes the corresponding Lie group element.

As rotations are periodic and one of the simplest forms of continuous symmetries, this perspective is useful for understanding the ability of the M-layer to learn periodicity in input features.

Example Dynamical Systems Interpretation

Recent work has proposed a dynamical systems interpretation of some DNN architectures. The NODE architecture uses a nonlinear and not time-invariant ODE that is provided by trainable neural units, and computes the time evolution of a vector that is constructed from the input features. This section discusses a similar interpretation of the M-layer.

Consider an M-layer with \tilde{T} defined as \tilde{T}₀₁₂=\tilde{T}₁₂₀=\tilde{T}₂₀₁=+1, \tilde{T}₂₁₀=\tilde{T}₁₀₂=\tilde{T}₀₂₁=−1, and 0 otherwise, with U as the 3×3 identity matrix, and with \tilde{B}=0. Given an input vector a, the corresponding matrix M is then

$$( \begin{matrix}0 & {a}_{2} & - {a}_{1} \\ - {a}_{2} & 0 & {a}_{0} \\ {a}_{1} & - {a}_{0} & 0\end{matrix} )$$

Plugging M into the linear and time invariant (LTI) ODE d/dt Y(t)=MY(t), we can observe that the ODE describes a rotation around the axis defined by a. Moreover, a solution to this ODE is given by Y(t)=exp(tM)Y(0). Thus, by choosing Sₘⱼₖ=(0)ₖ if m=j and 0 otherwise, the above M-layer can be understood as applying a rotation with input dependent angular velocity to some basis vector over a unit time interval.

More generally, one can consider the input features to provide affine parameters that define a time-invariant linear ODE, and the output of the M-layer to be an affine function of a vector that has evolved under the ODE over a unit time interval. In contrast, the NODE architecture uses a non-linear ODE that is not input dependent, which gets applied to an input-dependent feature vector.

Example Certified Robustness

This section shows that the mathematical structure of the M-layer allows a novel proof technique to produce closed-form expressions for guaranteed robustness bounds.

For any matrix norm ∥·∥, we have:

∥exp(X+Y)−exp(X)∥≤∥Y∥exp(∥Y∥)exp(∥X∥)

Also make use of the fact that ∥M∥_{F}≤\sqrt{n}∥M∥₂ for any n×n matrix, where ∥·∥_{F} is the Frobenius norm and ∥·∥₂ is the 2-norm of a matrix. Recall that the Frobenius norm of a matrix is equivalent to the 2-norm of the vector formed from the matrix entries.

Let M be the matrix to be exponentiated corresponding to a given input example x, and let M′ be the deviation to this matrix that corresponds to an input deviation of \tilde{x}, i.e. M+M′ is the matrix corresponding to input example x+\tilde{x}. Given that the mapping between x and M is linear, there is a per-model constant δᵢₙ such that ∥M′∥₂≤δᵢₙ∥\tilde{x}∥_{∞}.

The 2-norm of the difference between the outputs can be bound as follows:

∥Δ₀∥₂≤−0.1in ∥S∥₂∥exp(M+M′)−exp(M)∥_{F}≤

≤−0.1 in \sqrt{n}∥S∥₂∥exp(M+M′)−exp(M)∥₂≤

≤−0.1in \sqrt{n}∥S∥₂∥M′∥₂ exp(∥M′∥₂)exp(∥M∥₂)≤

≤−0.1 in \sqrt{n}∥S∥₂δᵢₙ∥δᵢₙ∥\tilde{x}∥_{∞}exp(δᵢₙ∥\tilde{x}∥_{∞})exp(∥M∥₂)

where ∥S∥₂ is computed by considering S a h×n·n rectangular matrix, and the first inequality follows from the fact that the tensor multiplication by S can be considered a matrix-vector multiplication between S and the result of matrix exponential seen as a n·n vector.

This inequality allows to compute the minimal L_{∞} change required in the input given the difference between the amount of accumulated evidence between the most likely class and other classes. Moreover, considering that ∥x∥_{∞} is bounded from above, for example by 1 in the case of CIFAR-10, we can obtain a Lipschitz bound by replacing the exp(δᵢₙ∥\tilde{x}∥_{∞}) term with a exp(δᵢₙ) term.

### Example Devices and Systems

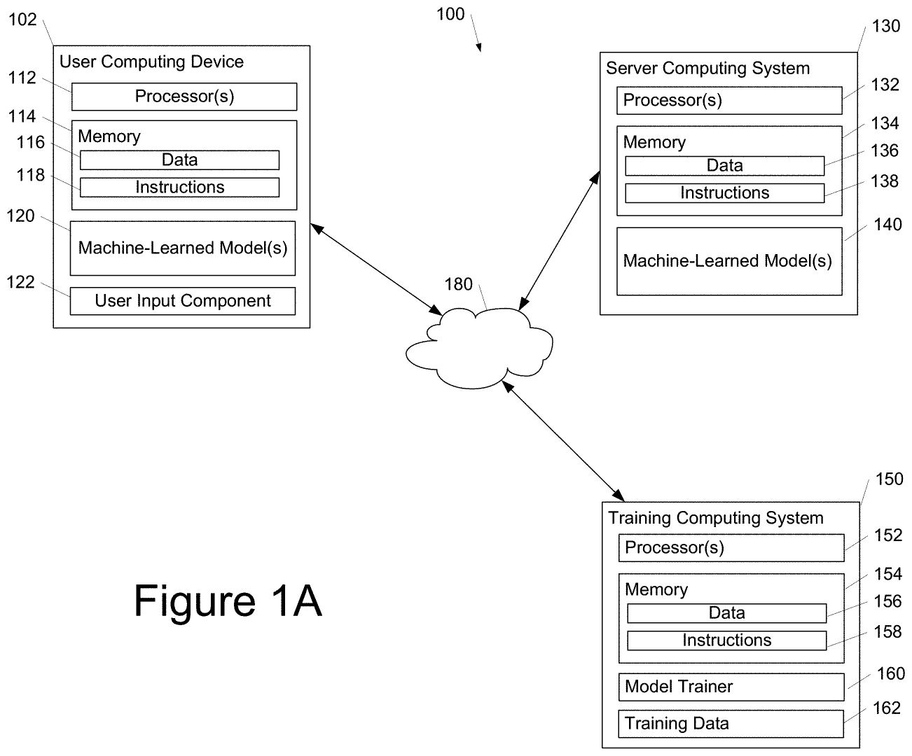

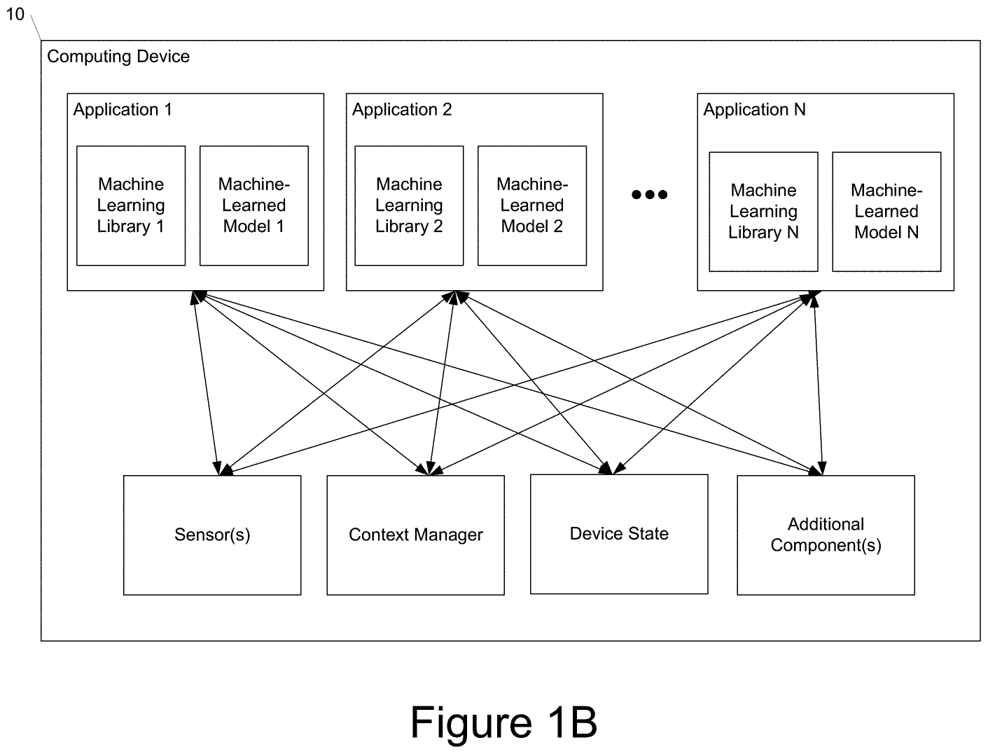

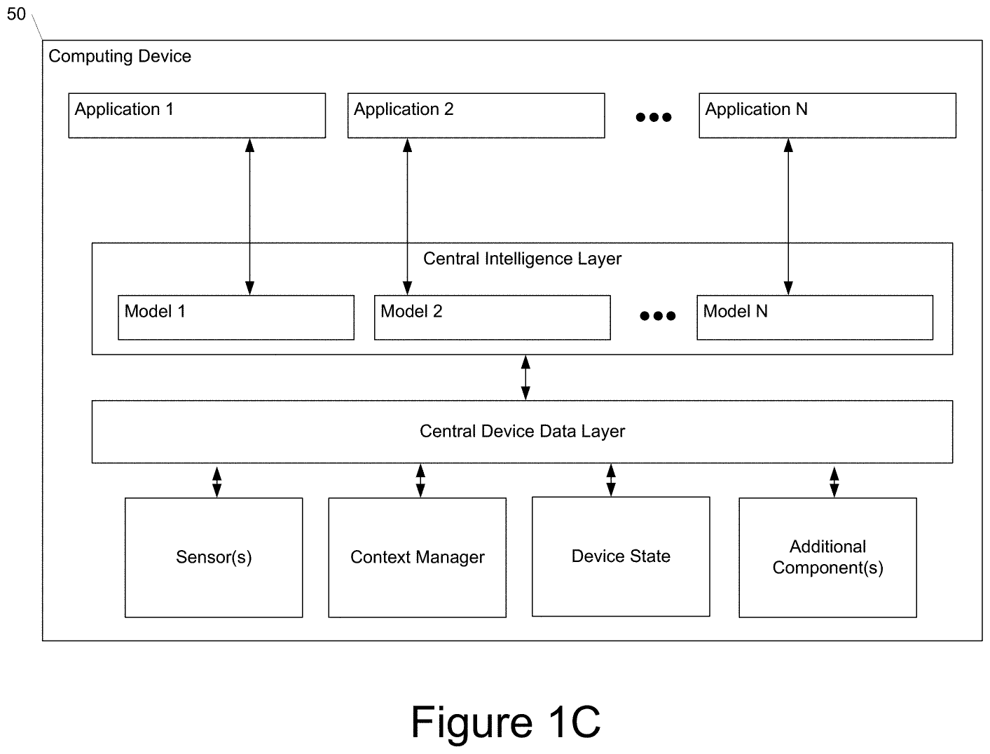

FIG. 1A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The processors 112 can also be or include various hardware accelerators such as graphics processing units (GPUs), tensor processing units (TPUs), and/or the like. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example models include matrix exponentiation models, e.g., either alone or combined with other model types.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The processors 132 can also be or include various hardware accelerators such as graphics processing units (GPUs), tensor processing units (TPUs), and/or the like. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models include matrix exponentiation models, e.g., either alone or combined with other model types.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for generating embeddings for data inputs, comprising:
one or more processors; and
one or more non-transitory computer-readable media that collectively store:
a machine-learned embedding model configured to receive and process a model input to generate a numerical embedding representation for the model input, wherein the machine-learned embedding model comprises one or more matrix exponentiation layers, wherein each of the one or more matrix exponentiation layers is configured to perform layer operations, the layer operations comprising:
receiving a layer input;
generating an intermediate matrix based on the layer input;
performing matrix exponentiation on the intermediate matrix to obtain an exponentiated matrix; and
generating a layer output based on the exponentiated matrix; and
instructions that, when executed by the one or more processors, cause the computing system to perform system operations, the system operations comprising:
receiving the model input; and
generating the numerical embedding representation for the model input by processing the model input with the machine-learned embedding model.

2. The computing system of claim 1, wherein the one or more matrix exponentiation layers comprise a single matrix exponentiation layer.

3. The computing system of claim 1, wherein the one or more matrix exponentiation layers comprise a plurality of matrix exponentiation layers.

4. The computing system of claim 3, wherein the plurality of matrix exponentiation layers are stacked in a sequence one after the other.

5. The computing system of claim 1, wherein generating the intermediate matrix based on the layer input comprises:
projecting the layer input to a latent feature embedding space to obtain an embedding tensor; and
mapping the embedding tensor to obtain an unbiased intermediate matrix.

6. The computing system of claim 5, wherein projecting the layer input to the latent feature embedding space to obtain the embedding tensor comprises using a first projection tensor to linearly project the layer input to the embedding tensor.

7. The computing system of claim 6, wherein the first projection tensor comprises one or more learned parameter values.

8. The computing system of claim 5, wherein mapping the embedding tensor to obtain the unbiased intermediate matrix comprises multiplying the embedding tensor with a mapping tensor.

9. The computing system of claim 8, wherein the mapping tensor comprises one or more learned parameter values.

10. The computing system of claim 5, wherein generating the intermediate matrix based on the layer input further comprises:
adding a first bias tensor to the unbiased intermediate matrix to obtain the intermediate matrix.

11. The computing system of claim 10, wherein the first bias tensor comprises one or more learned parameter values.

12. The computing system of claim 1, wherein generating the intermediate matrix based on the layer input comprises mapping the layer input to obtain an unbiased intermediate matrix.

13. The computing system of claim 1, wherein generating the layer output based on the exponentiated matrix comprises using a second projection tensor to linearly project the exponentiated matrix to an unbiased layer output, wherein the second projection tensor comprises one or more learned parameter values.

14. The computing system of claim 13, wherein generating the layer output based on the exponentiated matrix further comprises adding a second bias tensor to the layer output, wherein the second bias tensor comprises one or more learned parameter values.

15. The computing system of claim 1, wherein the numerical embedding representation comprises the layer output of a last matrix exponentiation layer of the one or more matrix exponentiation layers.

16. The computing system of claim 1, further comprising one or more hidden neural network layers that one or both of precede or follow the one or more matrix exponentiation layers.

17. The computing system of claim 1, wherein the intermediate matrix is an affine function of the layer input or the intermediate matrix comprises a feature weighted sum

18. The computing system of claim 1, wherein performing matrix exponentiation on the intermediate matrix to obtain an exponentiated matrix comprises:
performing matrix exponentiation on the intermediate matrix and subtracting a matrix exponential of zero from the result to obtain the exponentiated matrix.

19. The computing system of claim 1, wherein the numerical embedding representation comprises a continuous representation represented using floating-point numbers.

20. The computing system of claim 1, wherein the numerical embedding representation resides within an embedding space that facilitates multi-dimensional assessment.

21. The computing system of claim 1, wherein the system operations further comprise learning, based on a set of training data, improved values for one or more of the following components of the machine-learned model:
a first projection tensor;
a mapping tensor;
a first bias tensor;
a second projection tensor; and/or
a second bias tensor.

22. The computing system of claim 21, wherein said learning comprises performing one or more gradient-based optimization techniques comprising backpropagating a loss through the matrix exponentiation.

23. A computer-implemented method, the method comprising:
obtaining, by one or more computing devices, a numerical embedding representation for a data input, wherein the numerical embedding representation was generated for the data input by a machine-learned embedding model that comprises one or more matrix exponentiation layers, wherein each of the one or more matrix exponentiation layers is configured to generate an intermediate matrix based on a layer input, perform matrix exponentiation on the intermediate matrix to obtain an exponentiated matrix, and generate a layer output based on the exponentiated matrix; and
performing, by the one or more computing devices, a task with respect to the data input based at least in part on the numerical embedding representation.

24. The computer-implemented method of claim 23, wherein performing, by the one or more computing devices, the task with respect to the data input based at least in part on the numerical embedding representation comprises classifying, by the one or more computing devices, the data input based at least in part on the numerical embedding representation.

25. The computer-implemented method of claim 24, wherein classifying, by the one or more computing devices, the data input based at least in part on the numerical embedding representation comprises:
inputting, by the one or more computing devices, the numerical embedding representation into a machine-learned classification model configured to classify data inputs based on their embedding representations; and
receiving, by the one or more computing devices, a classification of the data input as an output of the machine-learned classification model.

26. The computer-implemented method of claim 23, wherein performing, by the one or more computing devices, the task with respect to the data input based at least in part on the numerical embedding representation comprises performing, by the one or more computing devices, a similarity search for the data input based at least in part on the numerical embedding representation.

27. The computer-implemented method of claim 23, wherein performing, by the one or more computing devices, the task with respect to the data input based at least in part on the numerical embedding representation comprises clustering, by the one or more computing devices, the data input with one or more other data inputs based at least in part on the numerical embedding representation.

28. The computer-implemented method of claim 23, wherein performing, by the one or more computing devices, the task with respect to the data input based at least in part on the numerical embedding representation comprises generating, by the one or more computing devices and using a machine-learned model, a prediction based at least in part on the numerical embedding representation.
